(19) United States
(12) Patent Application Publication
(10) Pub. No.: US 2021/0114225 A1
(43) Pub. Date: Apr. 22, 2021

(54) ITEM DELIVERY ROBOT, ITEM DELIVERY SYSTEM AND ROBOT MANAGEMENT APPARATUS

(71) Applicant: TOYOTA JIDOSHA KABUSHIKI KAISHA, Aichi-ken (JP)

(72) Inventors: Keima FUKUNAGA, Tokyo (JP); Tomohito MATSUOKA, Nagoya-shi (JP); Seiichi TSUNODA, Nisshin-shi (JP); Jiro GOTO, Seto-shi (JP); Yasutaka ETOU, Okazaki-shi (JP); Terumi UKAI, Toyokawa-shi (JP)

(21) Appl. No.: 17/012,049

(22) Filed: Sep. 4, 2020

(30) Foreign Application Priority Data
Oct. 16, 2019 (JP) 2019-189129

(51) Int. Cl. B25J 11/00; B25J 9/16; G05D 1/02

(52) U.S. Cl. CPC B25J 11/008; G05D 1/0248; G05D 1/0274; B25J 9/1664

(57) ABSTRACT

A self-propelled pallet serving as an item delivery robot includes a dynamic map memory serving as a map data memory; a BIM data memory serving as an internal structure memory; a road route generator; a coordinator; and an intra-building route generator. The road route generator obtains a road route that is a route based on the map data with an entrance of a destination building as a destination. The coordinator determines a corresponding entrance that is an entrance in the internal structure data, which corresponds to the entrance in the map data that is determined to be the destination in the road route. The intra-building route generator obtains an intra-building route that is a route based on the internal structure data, which extends from the corresponding entrance to a location that is the position of the destination individual determined based on the internal structure data.

### CROSS REFERENCE TO RELATED APPLICATION

This application claims priority to Japanese Patent Application No. 2019-189129 filed on Oct. 16, 2019, which is incorporated herein by reference in its entirety including the specification, claims, drawings, and abstract.

### TECHNICAL FIELD

The present specification discloses an item delivery robot that travels autonomously, a robot management apparatus that manages data held by the robot, and an item delivery system that includes the item delivery robot and the robot management apparatus.

### BACKGROUND

Service robots configured to deliver items have heretofore been known in the art as disclosed in, for example, Patent Publication No. JP 6336235 B. Such an item delivery robot travels autonomously to a destination while holding an item that is to be delivered.

When the item delivery robot travels autonomously, a route to the destination is set based on, for example, map data. The map data include information concerning, for example, positions and three-dimensional shapes of roads and buildings, and entrances and exits of buildings. To enable traveling autonomously, a sensor for recognizing surrounding environments is used to estimate a self-position and to recognize an environment so that the traveling is controlled based on the estimated self-position and the recognized environment.

With a further step forward, items may be delivered to, rather than a building such as an office building where a destination individual is located, the location of the destination individual (for example, the work desk of the destination individual) in the office building. This service is called direct delivery service. To provide this service using an item delivery robot, the item delivery robot should travel autonomously not only outside the building but also within the building.

To enable autonomous travel outside the building, map data are used for route generation as described above. To enable autonomous travel within the building, building internal structure data are used for route generation.

The map data and the building internal structure data have heretofore not been well coordinated with each other. For example, while the map data use a geographic coordinate system including latitude and longitude, the building internal structure data may use a three-dimensional orthogonal coordinate system (also called a world coordinate system) in which a certain point of the building serves as a point of origin. This makes it difficult to coordinate, for example, the destination of autonomous traveling outside the building with the starting point of autonomous traveling within the building in the internal structure data, and the item delivery robot that travels both outside and within the building may be hindered from traveling autonomously.

As a measure for addressing this drawback, the present specification discloses an item delivery robot, an item delivery system, and a robot management apparatus that enable the item delivery robot to autonomously travel both outside and within the building more smoothly than do conventional devices.

### SUMMARY

The present specification discloses an item delivery robot that travels autonomously to deliver an item. The item delivery robot includes a map data memory, an internal structure memory, a road route obtainer, a coordinator, and an intra-building route obtainer. The map data memory is capable of storing map data containing positions and shapes of one or more roads and one or more buildings, and positions of one or more entrances of the one or more buildings. The internal structure memory is capable of storing internal structure data concerning a destination building that is a position of a destination individual determined based on the map data. The road route obtainer obtains a road route that is a route based on the map data with an entrance of the destination building as a destination. The coordinator determines a corresponding entrance that is an entrance in the internal structure data, which corresponds to the entrance in the map data that is determined to be the destination in the road route. The intra-building route obtainer obtains an intra-building route that is a route based on the internal structure data, which extends from the corresponding entrance to a location that is the position of the destination individual determined based on the internal structure data.

The above-described configuration enables the item delivery robot to autonomously travel both outside and within the building smoothly, as the entrance in the map data, which is determined to be the destination in the road route, and the entrance in the internal structure data (corresponding entrance), which serves as the starting point in the intra-building route, are associated with each other.

In the above-described configuration, the coordinator may determine, as the corresponding entrance, the entrance in the internal structure data having a name that matches a name of the entrance in the map data that is determined to be the destination in the road route.

The above-described configuration enables reliable association, as the entrances in the map data and those in the internal structure data are associated with each other with reference to their names.

The present specification further discloses an item delivery system that includes the above-described item delivery robot, and a robot management apparatus that manages data held by the item delivery robot. The robot management apparatus includes a data supplier that supplies the internal structure data to the item delivery robot when the item delivery robot enters the destination building. At least one of the robot management apparatus and the item delivery robot includes a data eraser that deletes the internal structure data from the internal structure memory when the item delivery robot exits from the destination building.

The above-described configuration enables preventing the internal structure data, which is sometimes treated as confidential information, from leaking to the outside of the building.

In the above-described configuration, the data supplier may supply, to the item delivery robot, operation information concerning one or more elevators installed in the destination building when the item delivery robot enters the destination building. In this configuration, the intra-building route obtainer of the item delivery robot may generate the intra-building route on the basis of the operation information.

The above-described configuration enables selection of an elevator that stops at the floor where the destination individual is located when generating the intra-building route, as information concerning, for example, floors where elevators skip stopping and elevators that are out of operation is obtained.

In the above-described configuration, the data supplier may supply the internal structure data to the item delivery robot, including position information concerning a no-entry area in the destination building.

The above-described configuration enables generating an intra-building route that avoids the no-entry area, and enables delivery of an item in compliance with security policies of the building.

In the above-described configuration, the data supplier may supply the internal structure data to the item delivery robot, including position information concerning a drop-off and pickup area provided in the destination building. In this configuration, when generating the intra-building route, the intra-building route obtainer of the item delivery robot may set, as the destination, the drop-off and pickup area instead of the location of the destination individual when the location of the destination individual is included in the no-entry area.

The above-described configuration enables delivery of an item to the destination individual without entering the no-entry area.

The present specification discloses a robot management apparatus that manages data held by an item delivery robot that travels autonomously to deliver an item. The robot management apparatus includes a data supplier and a coordinator. The data supplier supplies, to the item delivery robot, map data containing positions and shapes of one or more roads and one or more buildings, and positions of one or more entrances of the one or more buildings, and internal structure data concerning a destination building that is a position of a destination individual determined based on the map data. The coordinator determines a corresponding entrance that is an entrance in the internal structure data, which corresponds to an entrance of the destination building in the map data that is determined to be the destination based on the map data.

The item delivery robot, the item delivery system, and the robot management apparatus disclosed in the present specification enable the item delivery robot to autonomously travel both outside and within the building more smoothly than do conventional devices.

### BRIEF DESCRIPTION OF DRAWINGS

Embodiments of the present disclosure will be described based on the following figures, wherein:

FIG. 1 illustrates a hardware configuration of an item delivery system according to an embodiment of the present disclosure by way of example;

FIG. 2 illustrates function blocks of a common server and a building management apparatus by way of example;

FIG. 3 illustrates function blocks of an item delivery robot (self-propelled pallet) by way of example;

FIG. 4 illustrates a dynamic map by way of example;

FIG. 5 illustrates a plan view (first floor) of a destination building by way of example;

FIG. 6 illustrates a plan view (fourth floor) of the destination building by way of example;

FIG. 7 illustrates a walk-through function based on BIM data;

FIG. 8 illustrates a user information list by way of example;

FIG. 9 illustrates a self-propelled pallet and a distribution vehicle for carrying the pallet;

FIG. 10 illustrates a road route;

FIG. 11 illustrates a camera-captured image by way of example;

FIG. 12 illustrates LiDAR sensor-captured three-dimensional point group data, which correspond to the view illustrated in FIG. 11, by way of example;

FIG. 13 illustrates a three-dimensional point group data clustering process by way of example;

FIG. 14 illustrates an image having been subjected to object recognition by way of example;

FIG. 15 illustrates a state in which the self-propelled pallet has entered the building through a robot-dedicated entrance;

FIG. 16 illustrates an entry processing flow executed in the item delivery system according to the illustrated embodiment by way of example;

FIG. 17 illustrates a plan view (fourth floor) of the destination building, in which a no-entry area is illustrated;

FIG. 18 illustrates a plan view (fourth floor) of the destination building, in which a no-entry area and a drop-off and pickup area are illustrated;

FIG. 19 illustrates a state in which the self-propelled pallet travels autonomously along an intra-building route using intra-building beacons by way of example;

FIG. 20 illustrates an exit processing flow executed in the item delivery system according to the illustrated embodiment by way of example; and

FIG. 21 illustrates another example of function blocks of the common server.

### DESCRIPTION OF EMBODIMENTS

### Item Delivery System

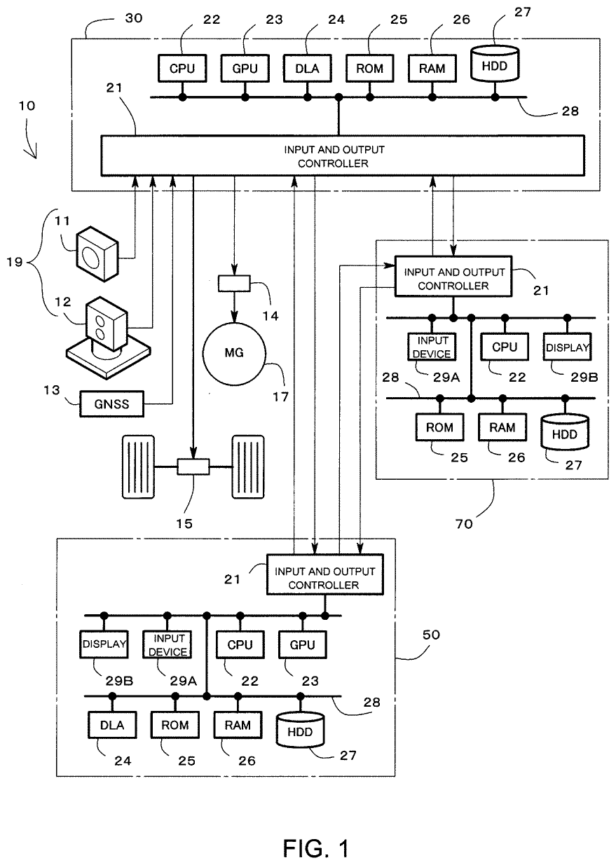

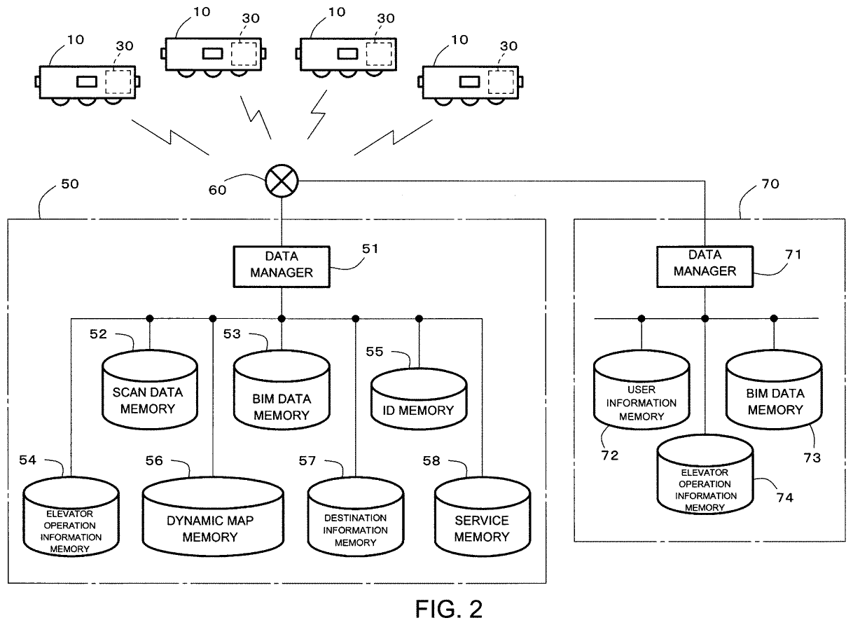

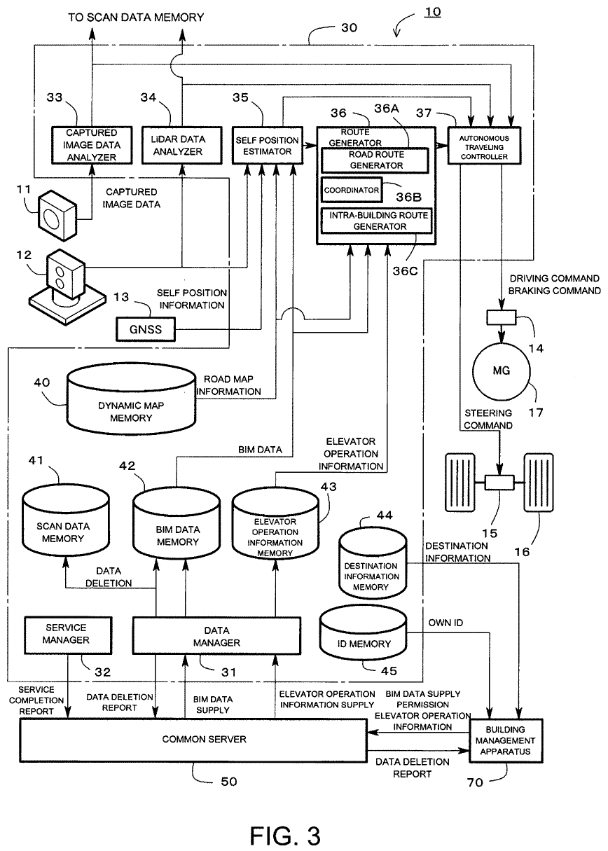

An item delivery system according to an embodiment of the present disclosure will be described below with reference to the accompanying drawings. FIG. 1 illustrates an item delivery system according to an embodiment of the present disclosure by way of example. This system includes a self-propelled pallet 10 (item delivery robot), a common server 50 (robot management apparatus), and a building management apparatus 70. FIG. 1 illustrates a hardware configuration of these devices included in the item delivery system by way of example. FIG. 2 illustrates a function block diagram of the common server 50 and the building management apparatus 70 by way of example. FIG. 3 illustrates a function block diagram of a controller 30 of the self-propelled pallet 10 by way of example.

### Common Server (Robot Management Apparatus)

The common server 50 is a robot management apparatus that manages data held by a plurality of self-propelled pallets 10. The common server 50 is capable of remotely controlling the behavior of the plurality of self-propelled pallets 10 by, for example, wireless communication. For example, the common server 50 serves as a dispatch center of the self-propelled pallets 10. The common server 50 is installed in, for example, a company that manages the self-propelled pallets 10.

The common server 50 is composed of, for example, a computer, and its clients include users who use the self-propelled pallets 10. For example, the common server 50 provides distribution service to the users via the self-propelled pallets 10. The common server 50 is installed in, for example, a company that manages the self-propelled pallets 10.

Referring to FIG. 1, the common server 50 includes, as its hardware configuration, an input and output controller 21 that controls input and output of data. The common server 50 includes, as processing devices, a CPU 22, a GPU 23 (Graphics Processing Unit), and a DLA 24 (Deep Learning Accelerator). The common server 50 includes, as storage devices, a ROM 25, a RAM 26, and a hard disk drive 27 (HDD). These components are connected to an internal bus 28.

The common server 50 also includes an input device 29A such as a keyboard and a mouse for entering data as appropriate. The common server 50 further includes a display 29B such as a display screen for viewing various types of information stored in this server. The input device 29A and the display 29B are connected to the internal bus 28.

FIG. 2 illustrates function blocks of the common server 50 by way of example. The common server 50 includes a data manager 51, a scan data memory 52, a BIM data memory 53 (internal structure memory), an elevator operation information memory 54, an ID memory 55, a dynamic map memory 56 (map memory), a destination information memory 57, and a service memory 58.

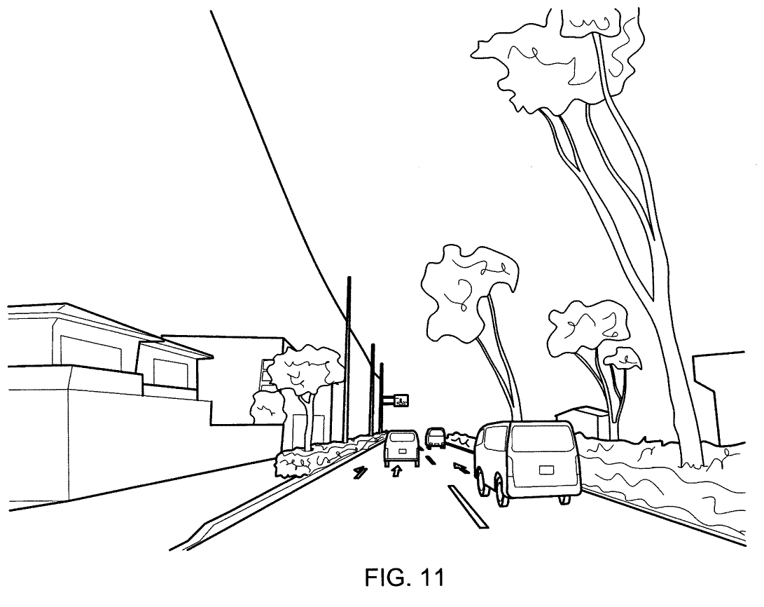

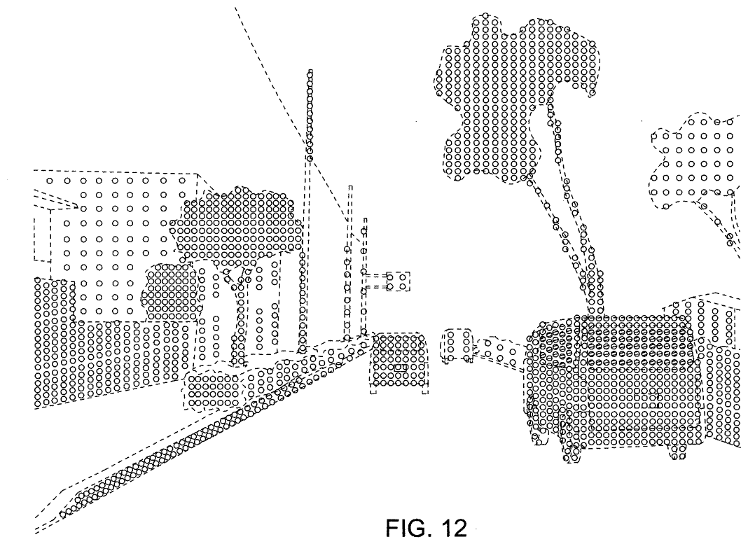

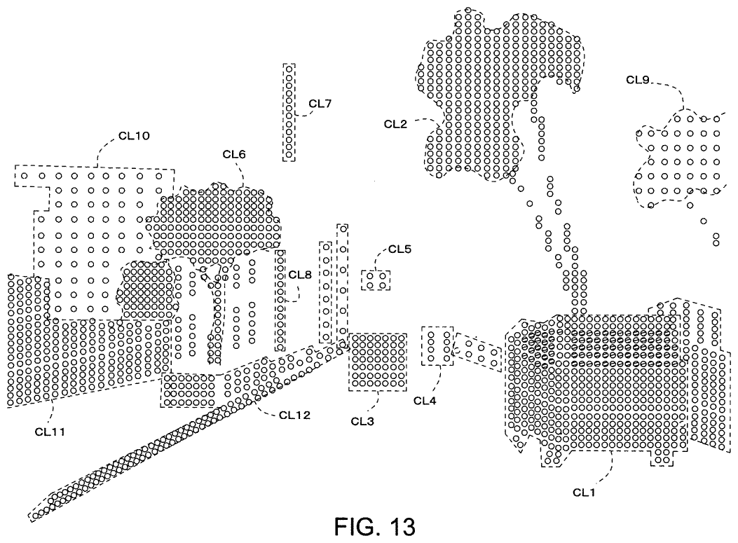

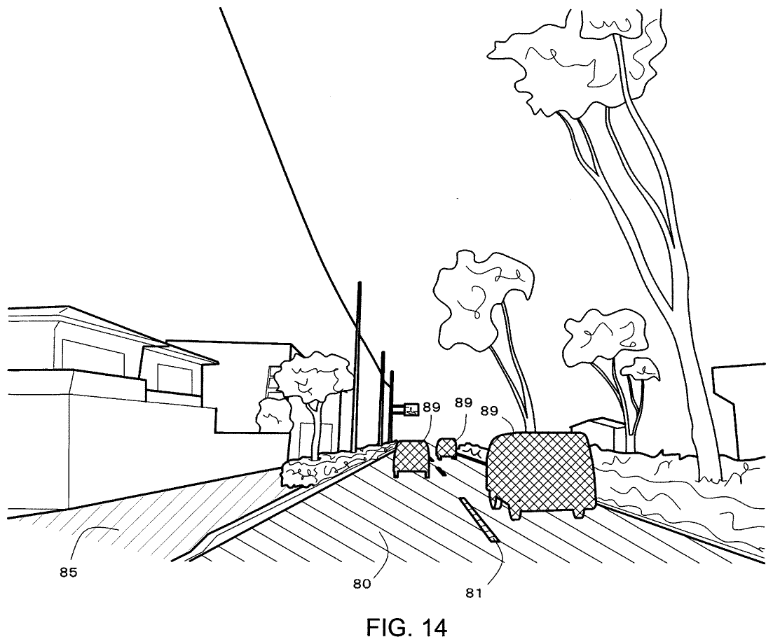

The scan data memory 52 stores data concerning surrounding environments obtained by self-propelled pallets 10 that are under control of the common server 50. Referring to FIG. 3, each self-propelled pallet 10 has a camera 11 and a LiDAR unit 12, which will be described below. The scan data memory 52 stores, as scan data, a surrounding image of the self-propelled pallet 10 captured by the camera 11 (see FIG. 11) and a three-dimensional point group representing distance-measuring data concerning a surrounding environment measured by the LiDAR unit 12 (see FIG. 12). Additionally, the scan data memory 52 also stores, as scan data, results of recognition of objects appearing in the surrounding image (see FIG. 14) and clustered three-dimensional point group data (see FIG. 13), which will be described below.

For example, such scan data is associated with position coordinates of the self-propelled pallet 10 as measured when these data are obtained, and the time at which these data are obtained. For example, each piece of scan data is associated with latitude and longitude coordinates of the self-propelled pallet 10 as measured when the corresponding image is captured, and the time at which this image is captured.

Returning to FIG. 2, the BIM data memory 53 stores BIM data supplied from the building management apparatus 70. The BIM data serve as building internal structure data. For example, the BIM data memory 53 stores BIM data (internal structure data) concerning a plurality of corporate buildings where distribution service is provided by the self-propelled pallet 10. As such, the BIM data memory 53 may also be referred to as internal structure memory.

While the BIM data serving as building internal structure data are sometimes treated as confidential information that is intrinsically prohibited from being taken out of the building, the common server 50 installed outside the building is allowed to permanently hold the BIM data based on, for example, an agreement with the building owner.

BIM (Building Information Modelling) is a computer-based process of virtually designing 3D constructions in a virtual space. For example, the BIM data include, as attribute information, three-dimensional sizes of components of a building such as an office building, component types and names such as pillars, beams, steel frames, pipes, and air ducts, component materials, and other information. Further, a three-dimensional model (also called BIM model) of the building is virtually constructed, and the BIM data include, as attribute information, names, floor areas, and other information concerning rooms in the building.

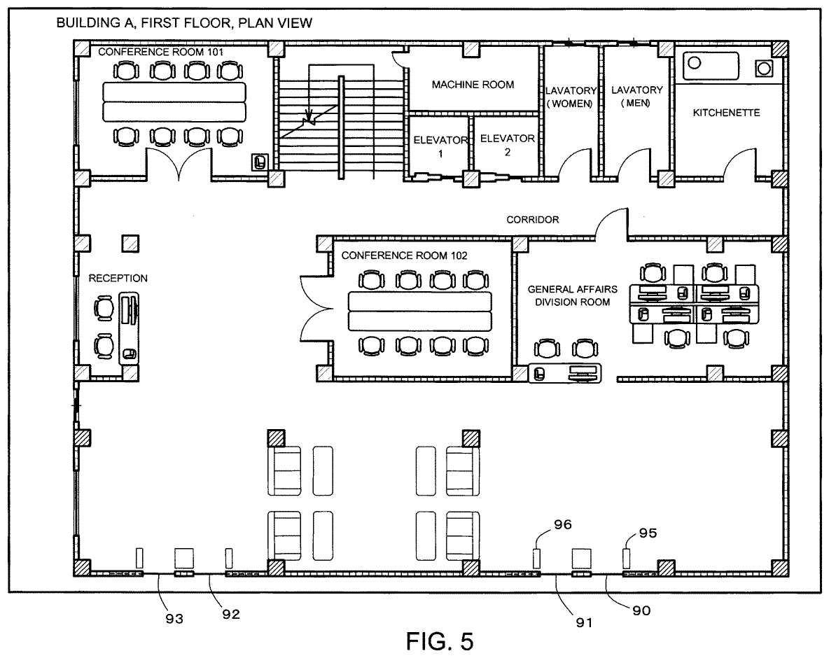

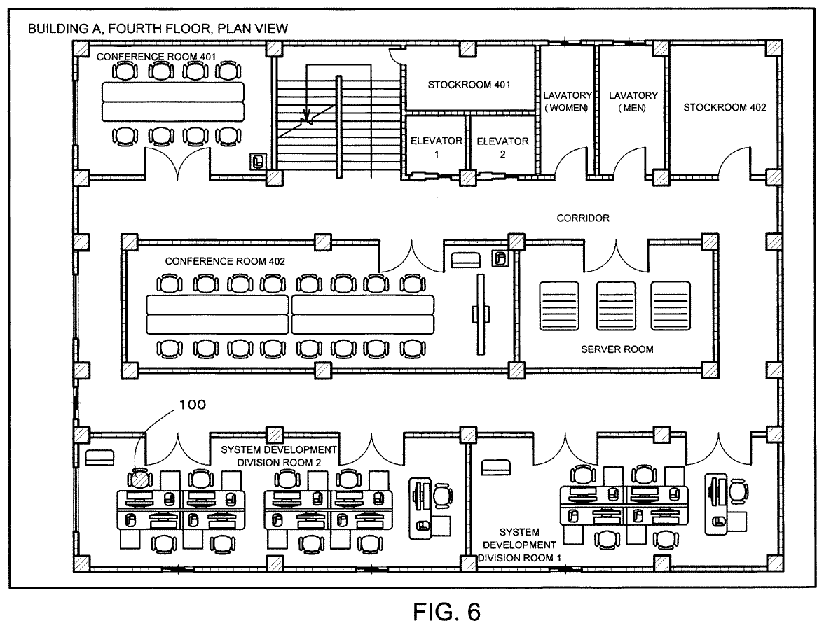

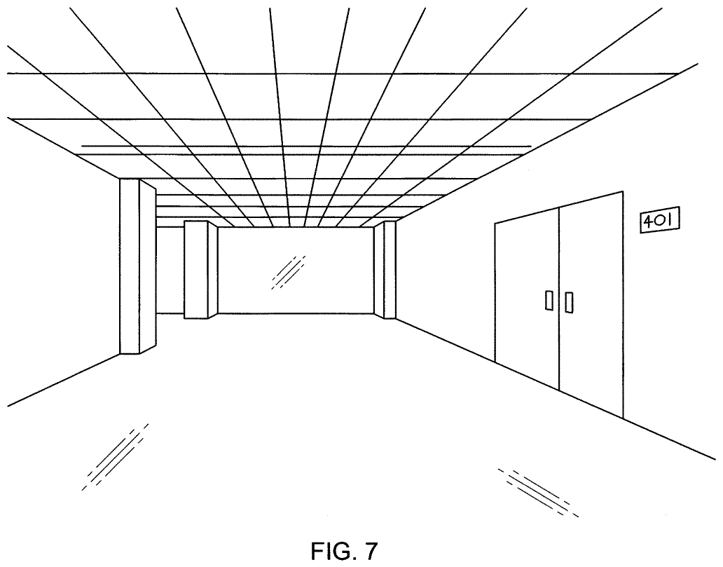

Cutting the BIM model in a horizontal direction enables obtainment of plan views of floors in the building as illustrated by way of example in FIGS. 5 and 6. Further, this enables a “walk-through” function in which the self-propelled pallet 10 virtually travels in the BIM model of the building as illustrated by way of example in FIG. 7. As will be described below, an intra-building route of the self-propelled pallet 10 is generated using the plan views of the floors. Further, a self-position of the self-propelled pallet 10 is estimated using the walk-through function.

As illustrated in FIGS. 5 and 6, the BIM data also include attribute information concerning furniture such as desks, chairs, telephones, and multifunctional printers that are placed in the building. For example, the BIM data include a three-dimensional shape of each piece of furniture, its position in the building, and an identification number (ID) such as a fixed asset number assigned to each piece of furniture.

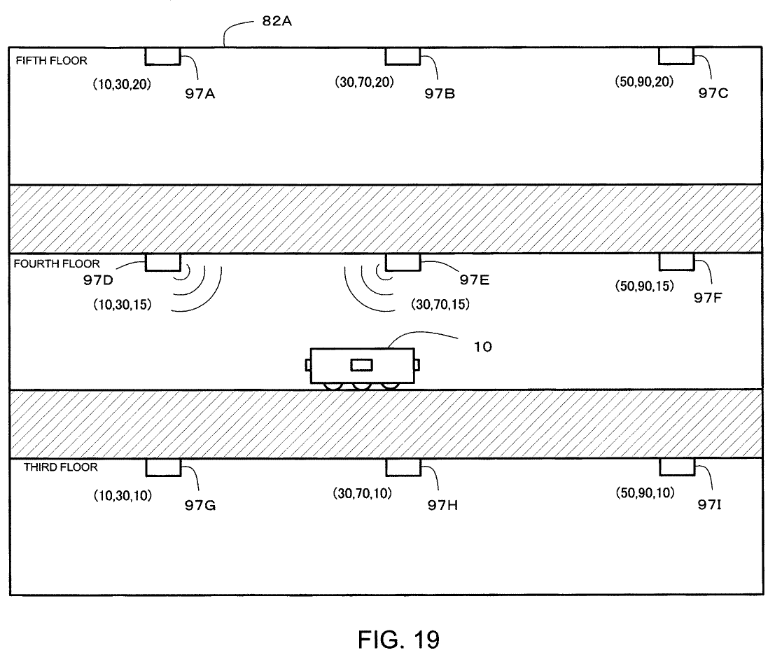

For example, the BIM model uses a world coordinate system in which a certain point in the virtual space serves as a point of origin. As illustrated by way of example in, for example, FIG. 19, positions in the building are represented by three-dimensional orthogonal X, Y, and Z coordinates.

Returning to FIG. 2, the elevator operation information memory 54 stores elevator operation information supplied from the building management apparatus 70. The elevator operation information refers to operation information concerning elevators, such as Elevator 1 and Elevator 2 in FIG. 5, installed in buildings that are under control of the building management apparatus 70.

The elevator operation information includes setting information indicating, for example, floors that are to be skipped (floors at which elevators do not stop) and availability information indicating, for example, elevators that are out of operation. Obtaining the elevator operation information as will be described below enables selection, as appropriate, of an elevator for going to the destination floor when the self-propelled pallet 10 travels autonomously in the building.

As the operation setting of elevators may be changed depending on time of day or other factors and may be changed day by day, as will be described below, updated elevator operation information is transmitted from the building management apparatus 70 to the common server 50 as the need arises.

The ID memory 55 stores identification numbers of the self-propelled pallets 10 that are under control of the common server 50. As will be described below, when, for example, the BIM data are supplied to a self-propelled pallet 10, an identification number (ID) of this pallet is used for identifying the self-propelled pallet 10 to which the BIM data are to be supplied.

The dynamic map memory 56 stores a dynamic map serving as map data. As such, the dynamic map memory 56 may also be referred to as map data memory.

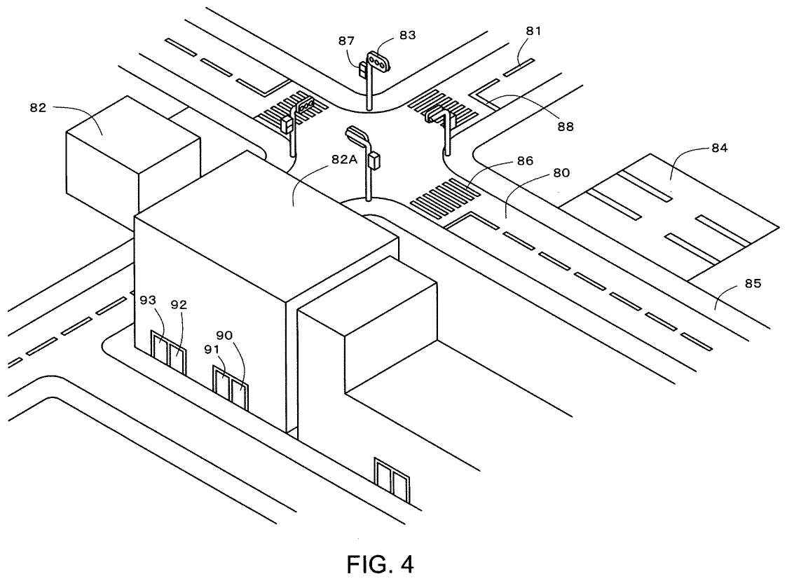

The dynamic map is a three-dimensional map, which, as illustrated by way of example in, for example, FIG. 4, contains positions and shapes (three-dimensional shapes) of vehicle roads 80. The three-dimensional shapes of the vehicle roads 80 include, for example, gradient and width. The dynamic map also contains positions of center lines 81, crosswalks 86, stop lines 88, and other marks on the vehicle roads 80.

Additionally, the dynamic map also contains positions and shapes (three-dimensional shapes) of buildings 82, vehicle traffic signals 83, and other constructions. The dynamic map further contains positions and shapes of parking lots 84.

While the above-described data are information used mainly when a vehicle travels autonomously on a vehicle road, in addition to such data, the dynamic map also contains pedestrian data. These data are also called pedestrian space network data, which contain positions and shapes (including width and gradient) of pedestrian sidewalks 85. In other words, the dynamic data contain positions and shapes of roads including the vehicle roads 80 and the pedestrian sidewalks 85. The dynamic map also contains positions and shapes of pedestrian traffic signals 87 as pedestrian data.

The dynamic map further contains positions of entrances and exits of the buildings 82 as, for example, destinations to which vehicles or pedestrians travel. For example, the dynamic map contains positions of a general-purpose entrance 92 and a general-purpose exit 93 of a destination building 82A, which will be described below. The dynamic map further contains positions of a robot-dedicated entrance 90 and a robot-dedicated exit 91 as an entrance and an exit dedicated to the self-propelled pallets 10.

For example, the dynamic map uses a geographic coordinate system including latitude and longitude. As will be described below, when a self-propelled pallet 10 travels autonomously on a road, the self-propelled pallet 10 obtains latitude and longitude of the self-position from a navigation system 13 (see FIG. 3) to thereby estimate the self-position on the dynamic map.

Returning to FIG. 2, the destination information memory 57 stores a destination to which the self-propelled pallet 10 is to deliver an item. For example, the common server 50 receives an item distribution request from a user who uses distribution service provided by the self-propelled pallet 10. The destination information memory 57 stores destination information including a destination address, a destination individual's name, and other information that are input when the item distribution request is received. To deliver the item, the destination information is transmitted from the common server 50 to the self-propelled pallet 10.

The service memory 58 stores user selected service details. For example, the service memory 58 stores, for example, a distribution item's name (such as document or pizza) for which distribution service is provided, and an enterprise that provides the distribution service (such as a distribution company or a pizza shop). The service memory 58 stores, for example, total time to be spent by the self-propelled pallet 10 for providing the service and distance to be traveled by the self-propelled pallet 10, which are used for fee calculation or other purposes.

The data manager 51 manages data held by the self-propelled pallet 10 (item delivery robot). The data manager 51 is capable of communicating with the self-propelled pallet 10 and the building management apparatus 70 via the Internet 60, wireless communication, or another communication network. As will be described below, the data manager 51 serves as a data supplier and a data eraser for the self-propelled pallet 10.

For example, the data manager 51 obtains scan data held by the self-propelled pallet 10, and deletes, from the self-propelled pallet 10, data identical to the obtained data so as to secure a storage area of this pallet. As will be described below, the data manager 51 allows the self-propelled pallet 10 to hold internal structure data (BIM data) concerning a building only when it is within this building.

### Building Management Apparatus

The building management apparatus 70 is an apparatus for performing maintenance, inspection, and power management of a building; for example, central management apparatuses installed in individual buildings correspond to this apparatus. Referring to FIG. 1, the building management apparatus 70 includes, as its hardware configuration, an input and output controller 21, a CPU 22, a ROM 25, a RAM 26, a hard disk drive 27 (HDD), an input device 29A, and a display 29B, and these components are connected to an internal bus 28.

FIG. 2 illustrates function blocks of the building management apparatus 70 by way of example. The building management apparatus 70 includes a data manager 71, a user information memory 72, a BIM data memory 73, and an elevator operation information memory 74.

The user information memory 72 stores user information for buildings that are under control of the building management apparatus 70. For example, for a building that is an office building, the user information memory 72 stores information concerning staff members who work in that building.

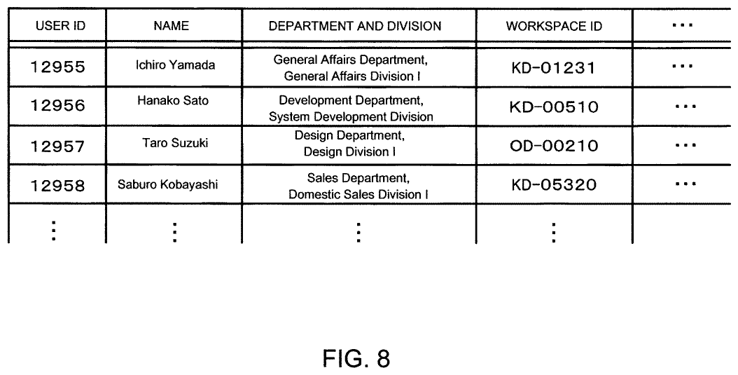

FIG. 8 illustrates a user information list that is stored in the user information memory 72 by way of example. Entries in this list include user ID, name, department and division, and workspace ID.

The user ID section lists identification numbers assigned to individual users; for example, staff member numbers or employee codes correspond to this information. The department and division section lists departments and divisions to which individual users belong. The workspace ID section lists control numbers (for example, fixed asset numbers) of assigned desks, chairs, or other pieces of furniture that are used by individual users in their working spaces. As will be described below, the workspace ID is included in the BIM data, and the location of a destination individual in the building internal structure data (BIM model) is set based on the workspace ID.

Returning to FIG. 2, the BIM data memory 73 stores BIM data serving as internal structure data concerning buildings that are under control of the building management apparatus 70. The BIM data are stored in the BIM data memory 53 of the common server 50 via the data manager 71.

The elevator operation information memory 74 stores operation information (for example, floors that are to be skipped, and non-operational information) concerning elevators installed in buildings that are under control of the building management apparatus 70. The elevator operation information is stored in the elevator operation information memory 54 of the common server 50 via the data manager 71.

### Self-Propelled Pallet (Item Delivery Robot)

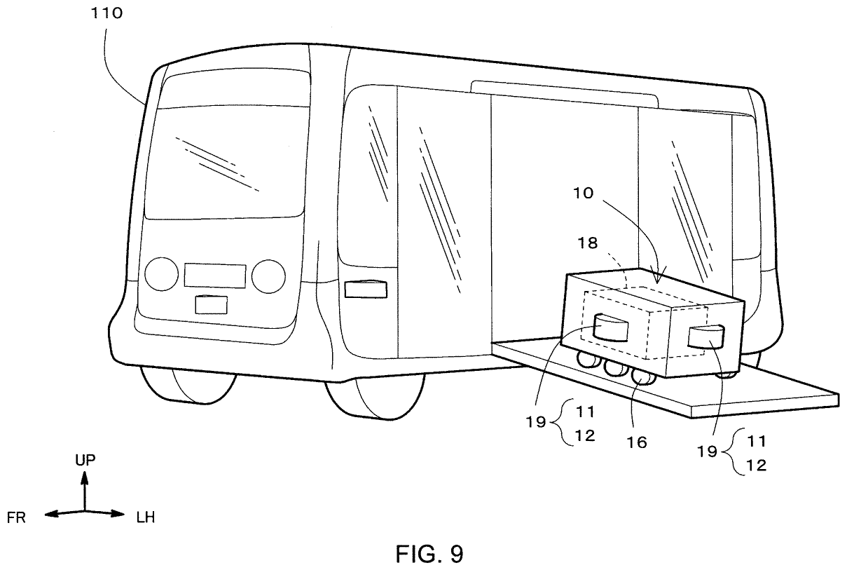

FIG. 9 illustrates the self-propelled pallet 10 by way of example. The self-propelled pallet 10 serves as an item delivery robot, which travels autonomously to deliver an item. For example, the self-propelled pallet 10 autonomously travels to the destination while housing an item 18 therein.

For example, the self-propelled pallet 10 travels to the vicinity of the destination while being carried on a distribution vehicle 110. For example, the self-propelled pallet 10 may be considered as a vehicle that replaces a push cart for carrying an item and a delivery person who pushes this cart to deliver the item to the destination individual.

Referring to FIG. 1, the self-propelled pallet 10 is an electrically powered vehicle that includes a rotary electric machine 17 (motor) serving as a driving power source, and a battery, which is not illustrated, serving as an electric power source. The self-propelled pallet 10 further incorporates a mechanism that enables autonomous travel. Specifically, the self-propelled pallet 10 includes, as a mechanism that enables autonomous travel, the camera 11, the LiDAR unit 12, the navigation system 13, and the controller 30.

Referring to FIG. 9, the self-propelled pallet 10 has sensor units 19 on its front surface, rear surface, and side surfaces. Each of the sensor units 19 includes the camera 11 (see FIG. 3) and the LiDAR unit 12.

The LiDAR unit 12 is a sensor unit for autonomous traveling that uses LiDAR (Light Detection and Ranging) which is a technique to measure the distance to an object around it using a laser beam. The LiDAR unit 12 includes an emitter that emits an infrared laser beam toward the outside, a receiver that receives reflection of the laser beam, and a motor that causes the emitter and the receiver to rotate.

For example, the emitter emits an infrared laser beam toward the outside. When a laser beam emitted from the emitter is incident upon an object around the self-propelled pallet 10, reflection of the laser beam is received by the receiver. A distance between a reflecting point and the receiver is determined based on a length of time from the emission from the emitter to the reception at the receiver. The emitter and the receiver are caused to rotate by the action of the motor so that a laser beam is scanned in the horizontal direction and in the vertical direction. This enables creation of three-dimensional point group data concerning the surrounding environment around the self-propelled pallet 10, as illustrated by way of example in, for example, FIG. 12.

Returning to FIG. 1, the camera 11 captures an image of a field of view that is similar to that covered by the LiDAR unit 12. The camera 11 includes, for example, an image sensor such as a CMOS sensor or a CCD sensor. An image (captured image) that is captured by the camera 11 is used for autonomous traveling control, as will be described below.

The navigation system 13 is a system that performs positioning using artificial satellites; for example, a GNSS (Global Navigation Satellite System) is used. As will be described below, using the navigation system 13 and the dynamic map enables estimation of a self-position with an accuracy within a positioning error range of artificial satellites.

The controller 30 may be, for example, an electronic control unit (ECU) of the self-propelled pallet 10 and is composed of a computer. The controller 30 may have a circuit configuration similar to that of the common server 50, and includes, for example, an input and output controller 21, a CPU 22, a GPU 23, a DLA 24, a ROM 25, a RAM 26, and a hard disk drive 27 (HDD). These components are connected to an internal bus 28.

At least one of the ROM 25 and the hard disk drive 27 serving as storage devices stores a program for performing autonomous driving control of the self-propelled pallet 10. Specifically, these storage devices store a program for executing a road route generation flow, an entry processing flow, an intra-building route generation flow, and an exit processing flow, which will be described below.

The above-described flow execution program, when executed, provides the controller 30 with function blocks as illustrated in FIG. 3. The function blocks include a data manager 31 (data eraser), a service manager 32, a captured image data analyzer 33, a LiDAR data analyzer 34, a self-position estimator 35, a route generator 36, and an autonomous traveling controller 37. The functions of these function blocks will be described below.

The self-propelled pallet 10 also includes, as storage devices, a dynamic map memory 40 (map data memory), a scan data memory 41, a BIM data memory 42 (internal structure memory), an elevator operation information memory 43, a destination information memory 44, and an ID memory 45.

The dynamic map memory 40 (map data memory) is capable of storing dynamic map data serving as map data. The dynamic map data are supplied from the data manager 51 of the common server 50 (see FIG. 2). For example, the dynamic map data stored in the dynamic map memory 40 may be a portion of data held by the common server 50. For example, as described above, when the self-propelled pallet 10 is carried to the vicinity of a destination by the distribution vehicle 110 (see FIG. 9), dynamic map data concerning an area around the destination, or, in other words, the destination address, are supplied to the dynamic map memory 40. This reduces the burden on the storage area of the self-propelled pallet 10.

The BIM data memory 42 (internal structure memory) is capable of storing BIM data serving as internal structure data concerning a building where the destination individual is located; that is, the destination building 82A (see FIG. 4). The BIM data are supplied from the data manager 51 of the common server 50 (see FIG. 2). As will be described below, the self-propelled pallet 10 is supplied with the BIM data only during a period of time in which this pallet stays within the destination building 82A.

Returning to FIG. 3, the elevator operation information memory 43 stores operation information concerning elevators installed in the destination building 82A (see FIG. 4). The operation information is supplied from the building management apparatus 70, which has the destination building 82A under its control, via the common server 50 to the self-propelled pallet 10.

The destination information memory 44 stores destination information including a destination address, a destination individual's name, and other information. At, for example, a distribution center, which is not illustrated, when an item is housed in the self-propelled pallet 10, the destination information is supplied from the common server 50 to the self-propelled pallet 10.

The ID memory 45 stores an identification number of the self-propelled pallet 10. For example, as initial setting of the self-propelled pallet 10, the identification number is stored in the ID memory 45.

### Autonomous Traveling on Road

Autonomous traveling control performed by the self-propelled pallet 10 (item delivery robot) according to the illustrated embodiment will be described below. Specifically, the following describes autonomous traveling control performed on a road, or, in other words, outside a building, and autonomous traveling control performed within a building, and further describes entry processing and exit processing that are performed at a point where switching between these two types of autonomous traveling control occurs.

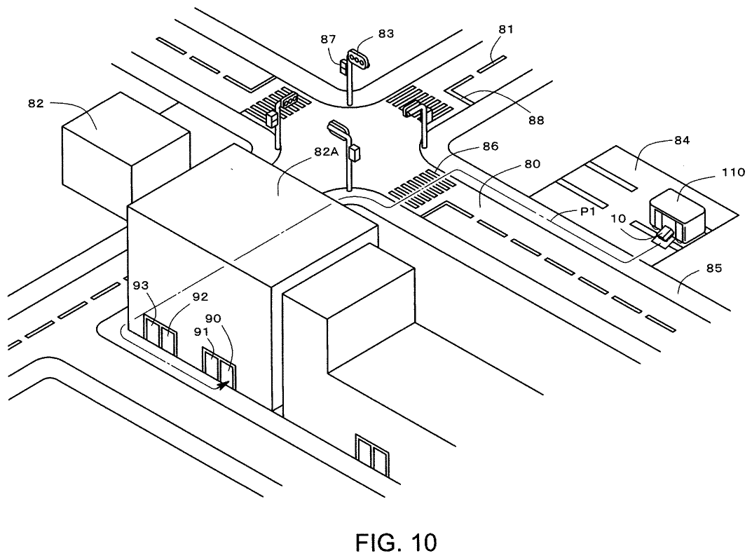

As illustrated by way of example in FIG. 10, the distribution vehicle 110 is parked in a parking lot 84 that is located in a vicinity of the destination building 82A. The self-propelled pallet 10 carried by the distribution vehicle 110 gets off the distribution vehicle 110 and travels autonomously to deliver an item to the destination building 82A.

The building where the destination individual is located; that is, the destination building 82A, is a building that is present at a position of the destination individual determined based on the dynamic map serving as map data. For example, the destination building 82A is a building that is present at a position on the dynamic map that represents the destination address stored in the destination information memory 44.

At this time, the self-propelled pallet 10 located outside the building has not yet been supplied with BIM data serving as internal structure data concerning the destination building 82A. As will be described below, the BIM data are supplied to the self-propelled pallet 10 upon entry into the destination building 82A.

Referring to FIG. 3, the self-position of the self-propelled pallet 10 is estimated using the surrounding map data concerning the destination building 82A stored in the dynamic map memory 40 and the navigation system 13. Latitude and longitude information concerning the self-propelled pallet 10 is transmitted from the navigation system 13 serving as a satellite positioning system to the self-position estimator 35. Further, a point of location on the dynamic map that corresponds to the latitude and longitude information concerning the self-propelled pallet 10 is determined. The self-position of the self-propelled pallet 10 within a satellite positioning error range (for example, ±10 cm) is estimated in this manner.

The self-position estimator 35 further obtains, from the LiDAR unit 12, three-dimensional point group data (scan data) concerning the surrounding environment of the self-propelled pallet 10, as illustrated by way of example in FIG. 12. Matching the three-dimensional point group data and the three-dimensional map data of the dynamic map enables estimation of the self-position of the self-propelled pallet 10 with an error less than the satellite positioning error.

The route generator 36 includes a road route generator 36A (road route obtainer) that generates a road route using the dynamic map (map data), in which the estimated self-position is set to the starting point, and the robot-dedicated entrance 90 of the destination building 82A (see FIG. 10) is set to the destination.

For example, if the self-propelled pallet 10 that travels slowly at a maximum velocity of, for example, 15 km/h travels on a vehicle road 80, traffic congestion may be caused by the self-propelled pallet 10. To avoid this situation, the self-propelled pallet 10 may be considered as a device that replaces a push cart carrying an item thereon and a delivery person pushing this cart, and a route similar to a pedestrian route may be generated as a route for the self-propelled pallet 10. The road route generator 36A generates, from data concerning the pedestrian sidewalks 85 and crosswalks 86, and other data stored in the dynamic map, a road route P1 starting from the self-position to the robot-dedicated entrance 90.

After the road route generator 36A generates and obtains the road route P1, the self-propelled pallet 10 travels autonomously based on this road route P1. Three-dimensional point group data concerning the surrounding environment around the self-propelled pallet 10 are obtained by the LiDAR unit 12. An image of the surrounding environment around the self-propelled pallet 10 is captured by the camera 11.

The captured image data analyzer 33 obtains a captured image as illustrated by way of example in FIG. 11, which is captured by the camera 11. FIG. 11 illustrates an example of a captured image that is captured at the time of traveling on a vehicle road. Subjecting this image to a known deep learning process such as SSD (Single Shot Multibox Detector) or YOLO (You Only Look Once) using supervised learning enables detection of objects in the image and further enables recognition of their attributes (for example, vehicle, pedestrian, and construction). As illustrated by way of example in, for example, FIG. 14, vehicles 89, a vehicle road 80, a center line 81, and a pedestrian sidewalk 85 are recognized from the captured image.

Referring to FIG. 3, the LiDAR data analyzer 34 obtains three-dimensional point group data (see FIG. 12) from the LiDAR unit 12. The LiDAR data analyzer 34 then executes clustering to split a three-dimensional point group into a plurality of clusters. In other words, the LiDAR data analyzer 34 produces clusters by separating a three-dimensional point group into groups of points as desired. Any known clustering method may be used; for example, Euclidean clustering may be used, in which Euclidean distances between individual reflecting points are used to gather into a cluster a group of points having small distances from each other. For example, in FIG. 13, through clustering, the three-dimensional point group data are split into clusters CL1 to CL12.

The autonomous traveling controller 37 controls the traveling of the self-propelled pallet 10 using the captured image that is analyzed by the captured image data analyzer 33, object information that is included in the captured image, clustered three-dimensional point group data that are analyzed by the LiDAR data analyzer 34, and self-position information that is estimated by the self-position estimator 35.

For example, superimposing the captured image and the three-dimensional point group data on each other enables obtainment of information indicating, for example, what attribute of an object is present at what distance from the self-propelled pallet 10. Using the superimposed information, the autonomous traveling controller 37 controls a driving mechanism 14 including an inverter and other devices and a steering mechanism 15 including an actuator and other devices.

### Entry Processing Flow

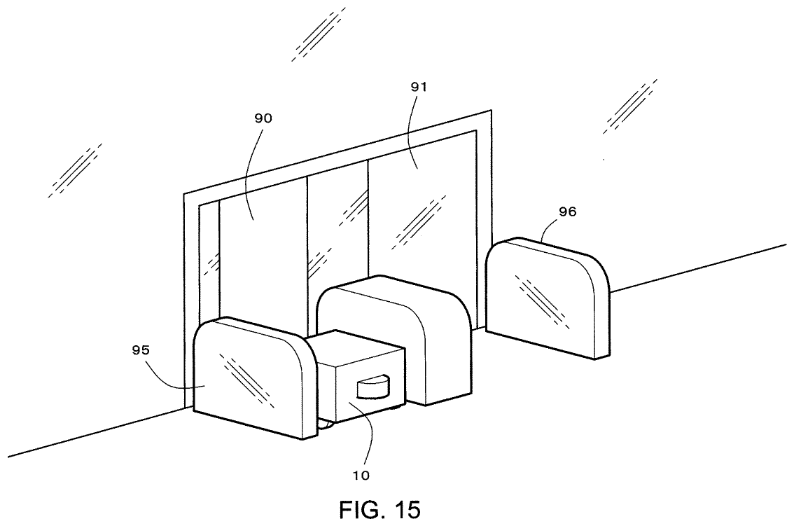

FIG. 15 illustrates a state in which the self-propelled pallet 10 has arrived at the robot-dedicated entrance 90 of the destination building 82A by way of example. A security gate 95 is installed at the robot-dedicated entrance 90, and entry processing is performed via this gate between the building management apparatus 70 and the common server 50 and the self-propelled pallet 10. As will be described below, in the entry processing flow, the self-propelled pallet 10 that is permitted to travel within the building is supplied with BIM data serving as internal structure data concerning this building, upon entry into the building.

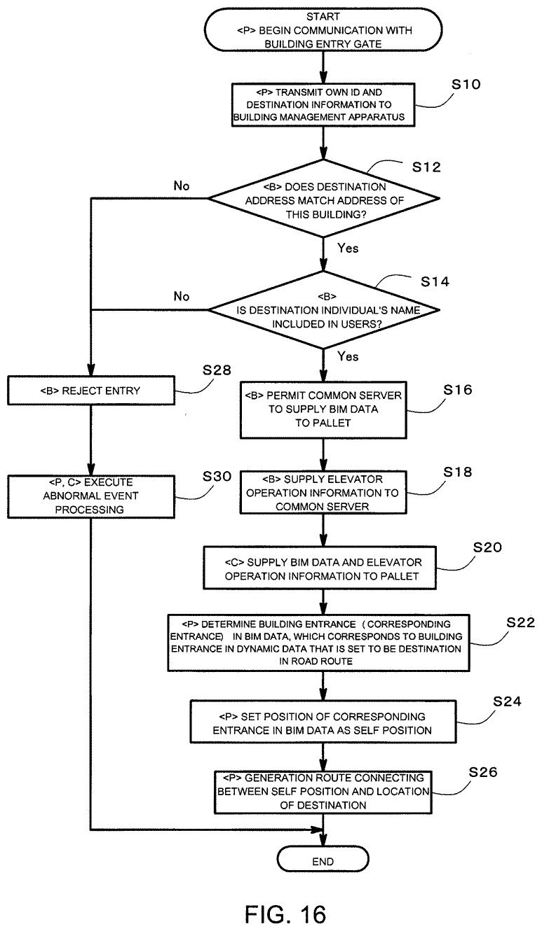

FIG. 16 illustrates an entry processing flowchart by way of example. In individual blocks, <P> indicates that the block is executed by the controller 30 of the self-propelled pallet 10, <B> indicates that the block is executed by the building management apparatus 70, and <C> indicates that the block is executed by the common server 50. In this entry processing flowchart, the flow starts from a point in time at which the self-propelled pallet 10 has arrived at the robot-dedicated entrance 90 and has begun communication with the security gate 95 for entry.

The controller 30 of the self-propelled pallet 10 communicates with the building management apparatus 70 via the security gate 95 by, for example, wireless communication. For example, the controller 30 extracts the own ID from the ID memory 45 (see FIG. 3) and transmits it to the building management apparatus 70. The controller 30 further transmits to the building management apparatus 70 a destination address and information concerning a destination individual from the destination information memory 44 (S10).

The building management apparatus 70 determines whether or not the destination address transmitted from the self-propelled pallet 10 matches the address of the destination building 82A (S12). If the addresses do not match, the building management apparatus 70 rejects entry of the self-propelled pallet 10 (S28). In response, the self-propelled pallet 10 and the common server 50 that manages this self-propelled pallet 10 execute abnormal event processing (S30). For example, an operator stationed at the common server 50 makes a telephone confirmation call with the destination individual. Alternatively, the common server 50 causes the self-propelled pallet 10 to return to the distribution vehicle 110 (see FIG. 10).

If, in step S12, the address transmitted from the self-propelled pallet 10 matches the address of the destination building 82A (see FIG. 4), the building management apparatus 70 determines whether or not the user information list (see FIG. 8) includes the destination individual's name (S14). If the user information list does not include the destination individual's name, the building management apparatus 70 rejects entry of the self-propelled pallet 10 as described above (S28, S30).

If, in step S14, the user information list includes the destination individual's name, the building management apparatus 70 permits the common server 50 to supply the BIM data to the self-propelled pallet 10 (S16).

Unlike the dynamic map or other map data, the BIM data serving as building internal structure data are, for security or other reasons, sometimes treated as confidential information that is prohibited from being taken out of the building. Therefore, in the item delivery system according to the illustrated embodiment, the self-propelled pallet 10 that has a valid reason for entry into a building is supplied with the BIM data serving as internal structure data concerning this building only when it is within this building.

The BIM data that are to be supplied to the self-propelled pallet 10 may be limited to minimum necessary data for distribution of an item to a destination individual. For example, the BIM data concerning a floor where the robot-dedicated entrance 90 is installed (first floor) as illustrated by way of example in FIG. 5 and a floor where a work desk 100 of the destination individual is installed (fourth floor) as illustrated by way of example in FIG. 6 may be supplied to the self-propelled pallet 10.

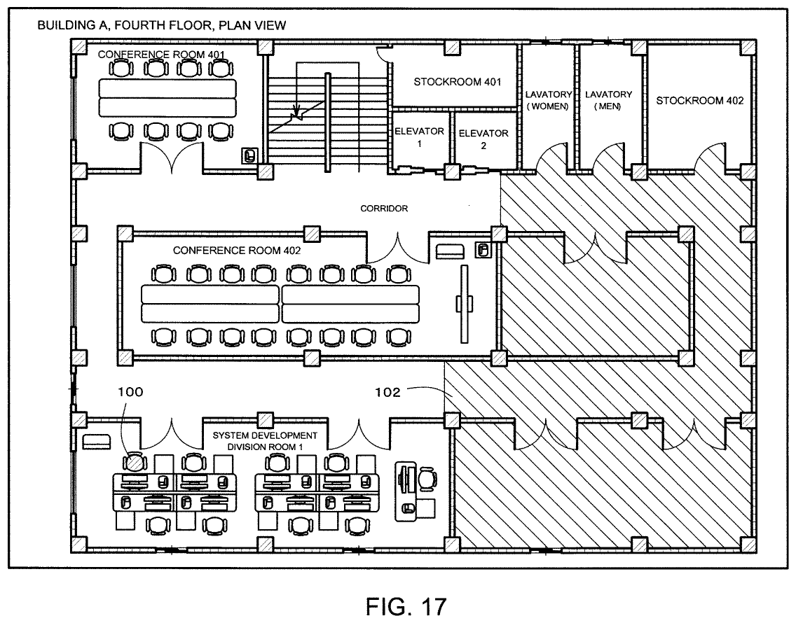

A building may include a no-entry area into which entry is prohibited unless specifically authorized. In such cases, the common server 50 supplies the BIM data to the self-propelled pallet 10, including position information concerning a no-entry area 102 in the destination building as illustrated by way of example in FIG. 17.

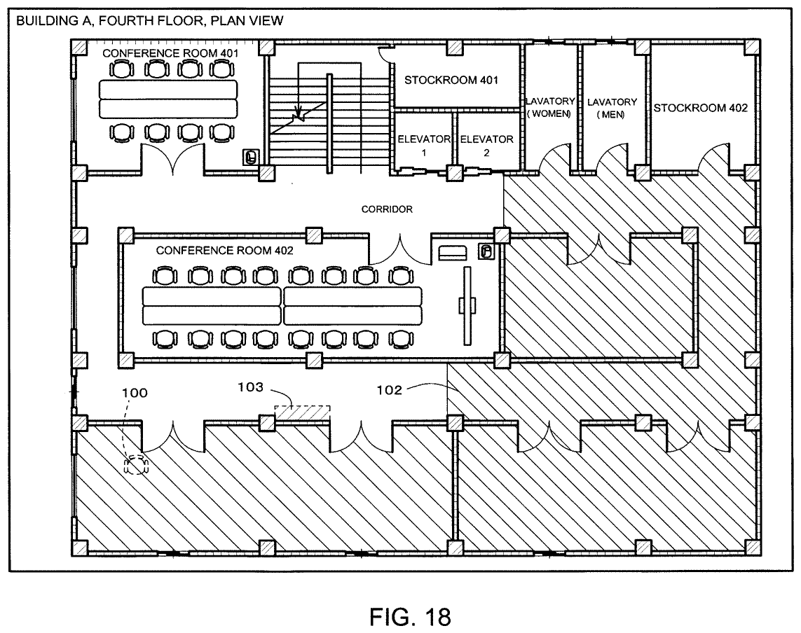

If, as illustrated by way of example in FIG. 18, the floor has a drop-off and pickup area 103, the BIM data including position information concerning the drop-off and pickup area 103 may be supplied to the self-propelled pallet 10.

Referring to FIG. 16, the data manager 71 of the building management apparatus 70 (see FIG. 2) supplies operation information concerning elevators installed in the destination building 82A via the data manager 51 of the common server 50 (S18). In response, the data manager 51 of the common server 50 stores the supplied elevator operation information in the elevator operation information memory 54, and supplies this information to the self-propelled pallet 10 (S20). The data manager 51 supplies the elevator operation information and the BIM data to the self-propelled pallet 10.

The BIM data and the elevator operation information supplied from the data manager 51 of the common server 50 are respectively stored in the BIM data memory 42 and the elevator operation information memory 43 via the data manager 31 of the self-propelled pallet 10 (see FIG. 3).

Next, a coordinator 36B of the self-propelled pallet 10 coordinates the dynamic map serving as map data and the BIM data serving as building internal structure data with each other. Specifically, an entrance (corresponding entrance) in the BIM data, which corresponds to the entrance in the dynamic data that is set to be the destination in the road route, is determined (S22).

For example, as the robot-dedicated entrance 90 (see FIG. 10) is set to be the destination in the road route as described above, the coordinator 36B searches the BIM data stored in the BIM data memory 42 for the robot-dedicated entrance 90 (see FIG. 5). For example, the coordinator 36B identifies, as the corresponding entrance, an entrance in the BIM data that has a name identical to the name “robot-dedicated entrance” of the entrance in the dynamic data. Entrance names can be searched for by referring to the above-described attribute information in the BIM data.

An orientation of the self-propelled pallet 10 (line of sight direction) in the BIM data may be determined using building appearance information in the dynamic data. For example, the dynamic data contains, as illustrated by way of example in FIG. 4, positions of not only the robot-dedicated entrance 90 but also the robot-dedicated exit 91, the general-purpose entrance 92, and the general-purpose exit 93. Aligning positions and angles of these entrances and exits with positions and angles of the entrances and exits in the BIM data by, for example, pattern matching enables determination of the orientation of the self-propelled pallet 10 (line of sight direction) in the BIM data.

Referring next to FIG. 3, an intra-building route generator 36C (intra-building route obtainer) sets the position of the corresponding entrance in the BIM data, or, in other words, the robot-dedicated entrance 90 (see FIG. 5), as the self-position of the self-propelled pallet 10 (S24). For example, a three-dimensional coordinate point of the robot-dedicated entrance 90 is set as a coordinate point of the self-position of the self-propelled pallet 10.

Next, the intra-building route generator 36C generates an intra-building route that is a route connecting between the self-position and the location of the destination individual (S26). The location of the destination individual refers to the position of the destination individual determined based on the BIM data serving as internal structure data. In traveling along the road route as described above, the position of the destination individual determined based on the map data, or, in other words, the building where the destination individual is located, is set to be the destination as the destination building 82A. In contrast, in traveling along the intra-building route, the position of the destination individual in the destination building 82A determined based on the BIM data is set to be the destination as the location of the destination individual.

For example, as illustrated by way of example in FIG. 6, the work desk 100 of the destination individual is set as the location of the destination individual. Further, a three-dimensional coordinate point of the work desk 100 is set as the destination. When the destination individual carries a position locator device such as an intra-company beacon, the position of this device may be set as the location of the destination individual (in other words, the destination).

Instead of the personal position of the destination individual, an organization unit such as a department or a division to which the destination individual belongs may be set as the location of the destination individual. In this configuration, a three-dimensional coordinate point of a room where, for example, a department or a division to which the destination individual belongs is placed, such as a coordinate point of the center point or a doorway of this room, may be set as the location of the destination individual.

Further, with reference to the elevator operation information, the intra-building route generator 36C selects an elevator that can reach the destination floor. For example, an elevator that is under normal operation and that can stop at floors including the destination floor is selected as part of the intra-building route. To call an elevator cage and designate a stopping floor, the self-propelled pallet 10 may have a controller that is capable of wireless communication with the elevator's control apparatus.

The generation of an intra-building route completes the entry processing flow illustrated by way of example in FIG. 16. The self-propelled pallet 10 travels autonomously along the intra-building route generated and obtained by the intra-building route generator 36C to the work desk 100 of the destination individual serving as a destination.

This autonomous traveling within the building is performed basically in a similar manner to the autonomous traveling along the road route as described above. However, the BIM data are used in place of the dynamic map. For example, the self-position is estimated by matching a 3D image obtained by using the walk-through function as illustrated by way of example in FIG. 7 and an image captured by the camera 11 (see FIG. 3).

As positioning signals from satellites are blocked by the building, the navigation system 13 serving as a satellite positioning system has a lower reception sensitivity than when traveling on a road. Therefore, the self-position of the self-propelled pallet 10 may be estimated using beacons installed in the building, 97A to 97I, which are illustrated by way of example in, for example, FIG. 19. FIG. 19 provides three-dimensional coordinates of the individual beacons 97A to 97I. To enable estimation of the self-position in this manner, the self-propelled pallet 10 includes, for example, a communications device that conforms to a communications protocol such as iBeacon (registered trademark) for communication with the beacons 97A to 97I.

After the self-propelled pallet 10 has arrived at the work desk 100 of the destination individual serving as a destination, the self-propelled pallet 10 authenticates the destination individual and hands over the item. For example, the destination individual is authenticated through a terminal that the destination individual is carrying, and then, the self-propelled pallet 10 is unlocked through, for example, a smart lock function provided in this terminal to allow the destination individual to pick up the item. At this time, the service manager 32 of the self-propelled pallet 10 (see FIG. 3) transmits a delivery service completion signal to the common server 50.

After the item has been handed over, the intra-building route generator 36C of the self-propelled pallet 10 generates a route for exit. For example, the intra-building route generator 36C generates a route in which the self-position is set to the starting point, and the robot-dedicated exit 91 (see FIG. 5) is set to the destination.

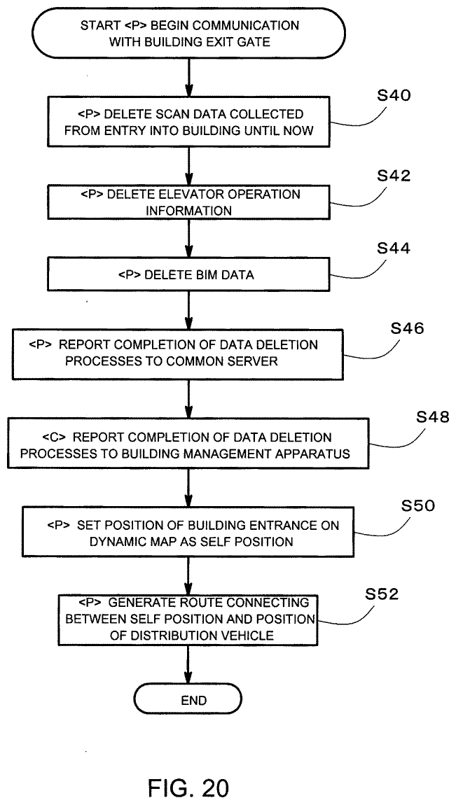

After the self-propelled pallet 10 has arrived at the robot-dedicated exit 91, the exit processing flow illustrated by way of example in FIG. 20 is executed. As illustrated by way of example in FIG. 15, a security gate 96 is installed at the robot-dedicated exit 91.

Exit processing is performed via this gate between the building management apparatus 70, and the common server 50 and the self-propelled pallet 10. As will be described below, the exit processing flow deletes information concerning the structure within the building stored in the self-propelled pallet 10.

FIG. 20 illustrates an exit processing flowchart by way of example. As in FIG. 16, <P> (the self-propelled pallet 10), <B> (the building management apparatus 70), and <C> (the common server 50) indicate which components execute individual blocks. In this exit processing flowchart, the flow starts from a point in time at which the self-propelled pallet 10 has arrived at the robot-dedicated exit 91 and has begun communication with the security gate 96 for exit.

Referring to FIG. 3, the data manager 31 (data eraser) of the self-propelled pallet 10 deletes the scan data collected from the entry into the destination building 82A (see FIG. 4) until now (exit) (S40). For example, the data manager 31 deletes the data collected from the time of entry into the destination building 82A until the present time, which are stored in the scan data memory 41.

Next, the data manager 31 deletes the elevator operation information stored in the elevator operation information memory 43 (S42). Additionally, the data manager 31 deletes the BIM data stored in the BIM data memory 42 (S44). For example, these deletion processes delete all data stored in the elevator operation information memory 43 and the BIM data memory 42.

Next, the data manager 31 reports, to the data manager 51 of the common server 50 (see FIG. 2), completion of the data deletion processes in steps S40 to S44 (S46). In response, the data manager 51 of the common server 50 reports, to the data manager 71 of the building management apparatus 70, completion of the data deletion processes (S48). This allows exit of the self-propelled pallet 10.

Next, the road route generator 36A of the self-propelled pallet 10 generates a road route using the dynamic map, in which the self-position is set to the starting point (S50), and the distribution vehicle 110 is set to the destination (S52). In this road route generation, for example, a route that is opposite to the road route P1 illustrated by way of example in FIG. 10 may be generated.

As described above, in the item delivery system according to the illustrated embodiment, the dynamic map serving as map data concerning the structure outside the building and the BIM data serving as internal structure data concerning the structure within the building are associated with each other with reference to the entrance that is the destination in the road route. This enables smooth transition from autonomous traveling along the road route to autonomous traveling within the building.

In the illustrated embodiment, the self-propelled pallet 10 is allowed to hold the BIM data only when it is within the building, and taking the BIM data out of the building is prevented. This enables autonomous traveling of the self-propelled pallet 10 within the building while maintaining the confidentiality of the BIM data.

### Another Example Concerning BIM Data Deletion

Although, in the above-described embodiment, the intra-building data deletion processes in steps S40 to S44 in FIG. 20 are executed by the data manager 31 of the self-propelled pallet 10 (see FIG. 3), embodiments of the present disclosure are not limited to this embodiment. The point is that at least one of the self-propelled pallet 10 and the common server 50 has a function of deleting the BIM data from the self-propelled pallet 10.

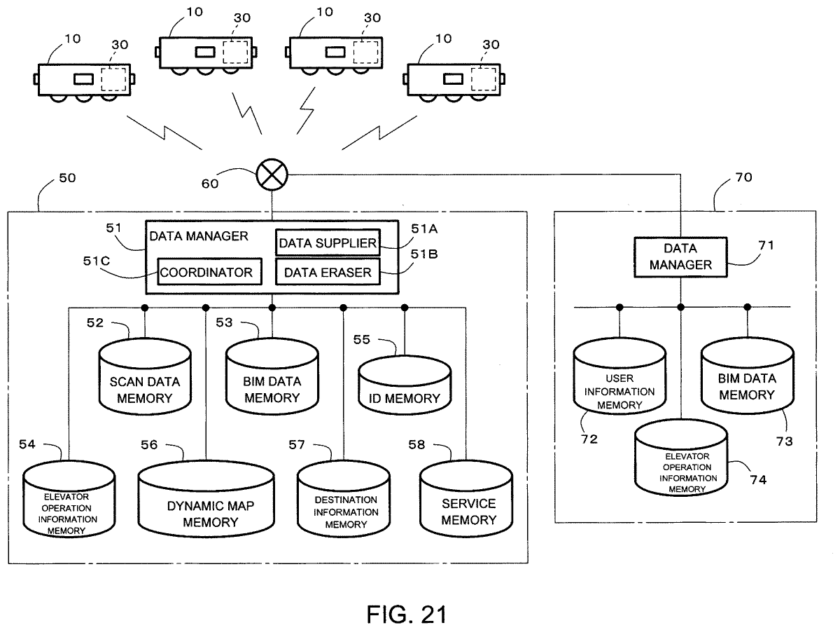

For example, the data manager 51 of the common server 50 may execute the data deletion processes in S40 to S44. Specifically, as illustrated by way of example in FIG. 21, the data manager 51 includes a data supplier 51A and a data eraser 51B. The data supplier 51A supplies the BIM data to the BIM data memory 42 and stores them therein when the self-propelled pallet 10 enters the building. Upon this entry into the building, the data supplier 51A also supplies the elevator operation information to the elevator operation information memory 43 and stores it therein. Upon exit of the self-propelled pallet 10 from the building, the data eraser 51B deletes the BIM data from the BIM data memory 42, and deletes the elevator operation information from the elevator operation information memory 43.

### Another Example Concerning Association Between Dynamic Data and BIM Data

Although, in the above-described embodiment, the association between the entrance in the dynamic data and the entrance in the BIM data in step S22 in FIG. 16 is executed by the controller 30 of the self-propelled pallet 10 (see FIG. 3), or, more specifically, by the coordinator 36B, embodiments of the present disclosure are not limited to this embodiment. For example, the data manager 51 of the common server 50 may execute the association process in S22 and may then supply the associated BIM data to the BIM data memory 42 of the self-propelled pallet 10. In this configuration, the data manager 51 of the common server 50 includes, as illustrated by way of example in FIG. 21, the data supplier 51A that supplies the BIM data and the elevator operation information to the self-propelled pallet 10, and a coordinator 51C that associates the dynamic data and the BIM data with each other.

### Another Example Concerning Destination

Although, in the above-described embodiment, the location of the destination individual is set to be the destination in the intra-building route in step S26 in FIG. 16, embodiments of the present disclosure are not limited to this embodiment. As illustrated in, for example, FIG. 18, the work desk 100 that is the location of the destination individual may be included in the no-entry area 102. In such cases, as the self-propelled pallet 10 is unable to reach the work desk 100, a substitute destination is set.

For example, the data manager 51 of the common server 50 (see FIG. 2) supplies the BIM data to the self-propelled pallet 10, including position information concerning the drop-off and pickup area 103 (FIG. 18) provided in the destination building 82A. In response, in step S26 in FIG. 16, when the work desk 100 that is the location of the destination individual is included in the no-entry area 102, the drop-off and pickup area 103 is set as the destination, and then an intra-building route is generated. This enables delivery of an item to the destination individual without entering the no-entry area 102.

### Another Example Concerning Route Generation

Although, in the above-described embodiment, the road route generator 36A and the intra-building route generator 36C of the self-propelled pallet 10 generate the road route and the intra-building route, embodiments of the present disclosure are not limited to this embodiment. For example, the common server 50 may generate the road route and the intra-building route, and the road route generator 36A and the intra-building route generator 36C may obtain the road route and the intra-building route that are generated by the common server 50. In other words, the road route generator 36A and the intra-building route generator 36C may have only the function of obtaining a route without serving the function of generating a route. In consideration of this configuration, the road route generator 36A and the intra-building route generator 36C may be referred to as a road route obtainer and an intra-building route obtainer.

The present disclosure is not limited to the present embodiments described above, and includes all changes and modifications without departing from the technical scope or the essence of the present disclosure defined by the claims.

1. An item delivery robot configured to travel autonomously to deliver an item, comprising:
a map data memory that is capable of storing map data containing positions and shapes of one or more roads and one or more buildings, and one or more positions of one or more entrances of the one or more buildings;
an internal structure memory that is capable of storing internal structure data concerning a destination building that is a position of a destination individual determined based on the map data;
a road route obtainer configured to obtain a road route that is a route based on the map data with an entrance of the destination building as a destination;
a coordinator configured to determine a corresponding entrance that is an entrance in the internal structure data, which corresponds to the entrance in the map data that is determined to be the destination in the road route; and
an intra-building route obtainer configured to obtain an intra-building route that is a route based on the internal structure data, which extends from the corresponding entrance to a location that is the position of the destination individual determined based on the internal structure data.

2. The item delivery robot according to claim 1, wherein the coordinator determines, as the corresponding entrance, the entrance in the internal structure data having a name that matches a name of the entrance in the map data that is determined to be the destination in the road route.

3. An item delivery system comprising:
the item delivery robot according to claim 1; and
a robot management apparatus configured to manage data held by the item delivery robot, wherein
the robot management apparatus comprises a data supplier configured to supply the internal structure data to the item delivery robot when the item delivery robot enters the destination building, and
at least one of the robot management apparatus and the item delivery robot comprises a data eraser configured to delete the internal structure data from the internal structure memory when the item delivery robot exits from the destination building.

4. The item delivery system according to claim 3, wherein
the data supplier supplies, to the item delivery robot, operation information concerning one or more elevators installed in the destination building when the item delivery robot enters the destination building, and
the intra-building route obtainer of the item delivery robot generates the intra-building route on the basis of the operation information.

5. The item delivery system according to claim 4, wherein the data supplier supplies the internal structure data to the item delivery robot, including position information concerning a no-entry area in the destination building.

6. The item delivery system according to claim 5, wherein
the data supplier supplies the internal structure data to the item delivery robot, including position information concerning a drop-off and pickup area provided in the destination building, and
when generating the intra-building route, the intra-building route obtainer of the item delivery robot sets, as the destination, the drop-off and pickup area instead of the location of the destination individual when the location of the destination individual is included in the no-entry area.

7. A robot management apparatus configured to manage data held by an item delivery robot that travels autonomously to deliver an item, comprising:
a data supplier configured to supply, to the item delivery robot, map data containing positions and shapes of one or more roads and one or more buildings, and one or more positions of one or more entrances of the one or more buildings, and internal structure data concerning a destination building that is a position of a destination individual determined based on the map data; and
a coordinator configured to determine a corresponding entrance that is an entrance in the internal structure data, which corresponds to an entrance of the destination building in the map data that is determined to be the destination based on the map data.
